(19) United States
(12) Patent Application Publication
(10) Pub. No.: US 2004/0098545 A1
(43) Pub. Date: May 20, 2004

(54) Transferring data in selectable transfer modes

(76) Inventors: Steven L. Pline, Boise, ID (US); Andrew M. Spencer, Eagle, ID (US); Kenneth J. Eldredge, Boise, ID (US); Michael Altree, Star, ID (US)

Correspondence Address: HEWLETT-PACKARD COMPANY, Intellectual Property Administration, P.O. Box 272400, Fort Collins, CO, 80527-2400, US

(21) Appl. No.: 10/295,651

(22) Filed: Nov. 15, 2002

(51) Int. Cl. G06F 12/00

(52) U.S. Cl. 711/154; 711/115

(57) ABSTRACT

Data storage systems and methods for writing data into a memory component and reading data from the memory component are disclosed. The systems and methods transfer data in one of a number of selectable transfer modes. In one implementation, the memory component comprises a memory controller for managing data within the memory component. The memory controller comprises a switching circuit that has a plurality of data input/output (I/O) terminals and multiple sets of transfer terminals. A standard transfer circuit is connected to one set of transfer terminals and a fast serial transfer circuit is connected to another set of transfer terminals. The memory controller further comprises a compression/decompression engine that compresses data.

### CROSS-REFERENCE TO RELATED APPLICATIONS

This application is related to copending U.S. patent application Ser. No. 10/243,263 (HP Docket No. 100110738-1), filed on Sep. 13, 2002, and entitled “System for Quickly Transferring Data,” which is incorporated by reference in its entirety herein.

### TECHNICAL FIELD OF THE INVENTION

The present invention is generally related to data storage and retrieval. More particularly, the present invention is related to systems and methods for writing data to memory cards and reading data from memory cards in one of a number of selectable data transfer modes.

### BACKGROUND OF THE INVENTION

Developers have manufactured different types of solid-state memory devices for storing digital data. These memory devices can be packaged into what is known as memory cards, which have increased in popularity in recent years. Memory cards are used in a variety of applications, such as in digital cameras and camcorders, music players, personal digital assistants (PDAs), personal computers, etc. These memory cards are typically very small in size and have specific physical specifications, or form factors. Typical memory cards have a data storage capacity in a range from about 2 megabytes (MB) to about 1 gigabyte (GB).

Although many memory cards provide large volumes of memory, the data transfer rate for storing large files into memory and retrieving files from memory are sometimes rather slow. For instance, if a photographer uses a digital camera that is capable of taking 5 pictures per second and if each picture takes up about 5 MB of data, the memory card must be capable of storing data at a rate of at least 25 MB per second. Existing memory cards are not capable of such transfer rates. In another example, if the photographer stores about 100 pictures in memory and each picture is about 5 MB, the pictures may be stored on a 512 MB memory card. However, with a slow data transfer rate, it may take up to 20 minutes to upload the pictures into a computer.

One solution to the slow data transfer rate has been to supply the host devices (such as digital cameras) with large amounts of static random access memory (SRAM) and dynamic random access memory (DRAM). SRAM and DRAM are volatile memory and may act as data buffers for non-volatile memory devices. These data buffers temporarily store data as it is being written to the memory devices or read from the memory devices so that the data is not lost. However, because of the slow data transfer rate into the non-volatile memory devices, data may get backed up in the data buffers, preventing the user from storing additional information until the data is eventually stored in the non-volatile memory. Another problem with this solution is that SRAM and DRAM are relatively expensive and tend to drive up the cost of the host devices. Thus, a need exists in the industry to provide a higher performance, faster data transfer rate, and lower cost alternative to the SRAM and DRAM solution and to address the aforementioned deficiencies and inadequacies.

### SUMMARY OF THE INVENTION

The present disclosure includes a data storage system for transferring data in one of a number of selectable data transfer modes. One embodiment of the data storage system comprises a memory controller, which manages data within a memory component. The memory controller includes a switching circuit having a plurality of data input/output (I/O) terminals and multiple sets of transfer terminals. A standard transfer circuit is connected to one set of the transfer terminals and a fast serial transfer circuit is connected to another set. The memory controller may further comprise a compression/decompression engine, which is connected in the data transfer path.

Another embodiment of the data storage system comprises a memory card that is removably attached to a host. The memory card comprises at least one memory bank and a memory controller that is connected to the memory banks. The memory controller comprises a switching circuit that switches between a standard transfer mode and a fast serial transfer mode and a compression/decompression engine that compresses and decompresses data.

### BRIEF DESCRIPTION OF THE DRAWINGS

Many aspects of the invention can be better understood with reference to the following drawings. Like reference numerals designate corresponding parts throughout the several views.

FIG. 1 is a block diagram of a general overall view of an embodiment of a data storage system.

FIG. 2 is a block diagram illustrating an example embodiment of the data storage system of FIG. 1.

FIG. 3 is a block diagram illustrating the details of an embodiment of the host that is shown in FIGS. 1 and 2.

FIGS. 4A and 4B are combined to form a block diagram illustrating the details of an embodiment of the memory controller that is shown in FIGS. 1 and 2.

FIG. 5 is a block diagram of an embodiment of a portion of the host shown in FIG. 3, wherein the embodiment is an example of a half-duplex configuration.

FIG. 6 is a block diagram of an embodiment of a portion of the memory controller shown in FIG. 4, configured to operate in conjunction with the half-duplex embodiment shown in FIG. 5.

FIG. 7 is a block diagram of an embodiment of a portion of the host shown in FIG. 3, wherein the embodiment is an example of a full-duplex configuration.

FIG. 8 is a block diagram of an embodiment of a portion of the memory controller shown in FIG. 4, configured to operate in conjunction with the full-duplex embodiment shown in FIG. 7.

FIG. 9 is a block diagram of an example embodiment of the compression/decompression engine shown in FIG. 4.

FIG. 10 is a block diagram of a first embodiment of the storage device interface shown in FIG. 4.

FIG. 11 is a block diagram of a second embodiment of the storage device interface shown in FIG. 4.

FIG. 12 is a flow chart illustrating the steps of an example data-writing command.

FIG. 13 is a flow chart illustrating the steps of an example data-reading command.

### DETAILED DESCRIPTION OF THE INVENTION

The present disclosure describes systems and methods for overcoming the inadequacies of the prior art. These systems and methods improve the existing memory cards by increasing the data transfer rate to provide faster storage and retrieval times, while at the same time conforming to the form factor of any one of the commonly-used memory cards, such as Secure Digital™, MultiMediaCard™, and Memory Stick™. A memory controller, described herein, is preferably located in the memory card and includes a switching circuit that allows the selection of a data transfer path from among multiple parallel paths along which data is transferred. One such path includes a circuit that transfers data in a fast serial transfer mode where data and clock are combined or separated via an encoding/decoding method (e.g. 8 b/10 b encoding). Not only can the memory controller be configured to switch among a number of selectable data transfer paths, but also the memory controller can be configured to compress data in real-time, which enhances the storage capacity of the media. The data path switching circuitry can be considered as a distinct aspect from the compression circuitry. Therefore, the data path switching circuitry may be implemented independently and incorporated into the memory controller with or without the compression circuitry, and vice versa.

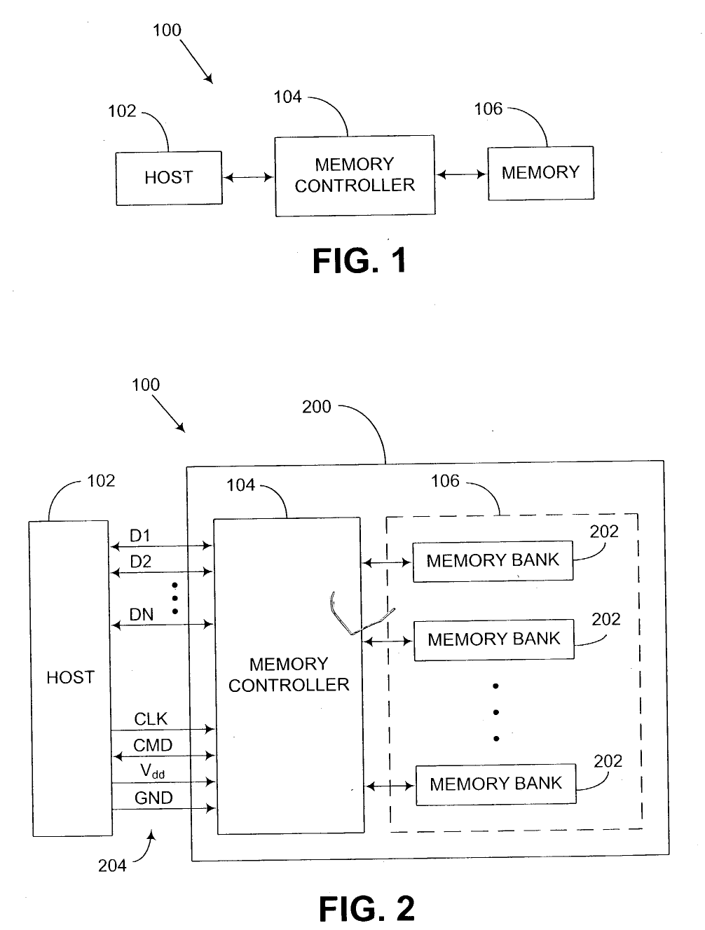

An overall view of an embodiment of a data storage system 100 is shown in FIG. 1. This figure illustrates a host 102 connected to a memory controller 104, which is further connected to memory 106. The host 102 may be any type of user device that reads data from memory 106 and/or writes data to memory 106. For example, the host 102 may be a processing system in a digital camera, which, in a data writing mode, is capable of capturing an image in digital form and writing the digital data representative of the captured image into memory 106. In a data-reading mode, the digital camera processing system may then retrieve data from memory 106 to upload data into a computer or to display images on a liquid crystal display (LCD), for example. Alternatively, the host 102 may be a processing system of an audio player that reads music data from memory 106 and audibly plays the music over a set of speakers. The audio player processing system may include data-writing capabilities such that music may be recorded in memory 106. The host 102 may optionally be configured as any other well-known system that utilizes memory 106, such as a processing system of a personal digital assistant (PDA), a processing system of a digital camcorder, etc.

The memory controller 104 is electrically connected between the host 102 and memory 106. The memory controller 104 manages the transfer of data from the host 102 to memory 106 during a data writing command and the transfer of data from memory 106 to the host 102 during a data reading command. In the preferred embodiments, the memory controller 104 and memory 106 are grouped together on a type of memory card that includes controller functionality and storage capability.

However, according to an alternative embodiment, the memory controller 104 may be located within the host 102. In this alternative embodiment, when the memory controller 104 compresses data using a particular algorithm and stores the compressed data on a separate memory component, the data can only be read back by the same host 102 or by a host that has a memory controller that comprises the same compression and decompression algorithms.

FIG. 2 is an embodiment of the data storage system 100 wherein the memory controller 104 and memory 106 are contained on a memory card 200. The memory card 200 may have any size, shape, pin configuration, and storage capacity. For example, the memory card 200 may be formed having the same form factor and specifications as any one of the well-known memory cards used in the market today, such as MultiMediaCards™, Secure Digital™, and Memory Stick™. The memory card 200 may be backward compatible with these or other memory devices that are in existence today and may be compatible with those that are developed in the future.

Memory 106 is shown in FIG. 2 as a plurality of memory banks 202, but may be configured as a single memory bank 202. The number of memory banks 202 may depend upon the ability of the particular memory banks 202 to transfer data as well as the data transfer rate of storage interface circuitry within the memory controller 104. The number may further depend upon the desired data transfer rate, as is described in more detail below. Data is preferably transferred between the memory controller 104 and the memory banks 202 in blocks or sectors. Each block or sector of data may have a predetermined block size, such as 512 bytes, for example, to conform to whatever block size the host 102 accesses data. The memory banks 202 comprise memory components that are capable of a high performance transfer of data blocks at fast data transfer speeds, such as, for instance, magnetic random access memory (MRAM) or atomic resolution storage (ARS).

Further illustrated in FIG. 2 are interface lines 204 between the host 102 and the memory controller 104. The interface lines 204 may include connection terminals, pins, pads, conductors, etc., that electrically connect the terminals of the host 102 with the compatible terminals of the memory card 200. A typical memory card contains specific terminals that are unique to the particular system and that are coupled only with a host having a compatible configuration. Despite the differences in the location and nomenclature of the terminals and lines of different host/card systems, the interface lines 204 of a typical system include a plurality of data lines D1, D2, . . . , DN, at least one clock line (CLK), at least one command line (CMD), at least one power line (V_{dd}), and at least one ground line (GND). The specifications of most memory cards normally call for at least two data lines. In the illustrated example of FIG. 2, the number of data lines is a number N. Preferably, the data storage system 100 comprises a form factor having at least three data lines to allow for half-duplex differential transmission and reception, as will be described below. If five or more data lines are available, a full-duplex differential transmission and reception configuration can be achieved, as will also be described below.

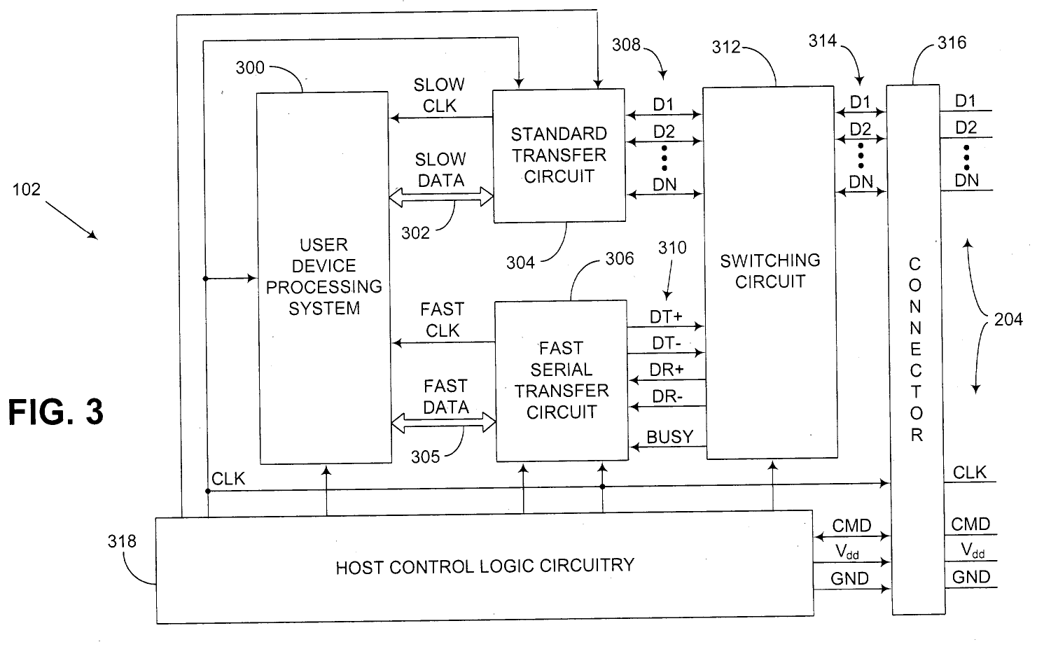

FIG. 3 illustrates a block diagram of an embodiment of the host 102. The embodiment of the host 102 shown in FIG. 3 comprises a user device processing system 300, which may comprise user circuitry and random access memory (RAM) as well as operating instructions configured in hardware and/or software. The user circuitry of the user device processing system 300 may include a data source or circuitry for creating original data and/or a destination device or circuitry for utilizing data retrieved from memory 106. In the digital camera example, the user device processing system 300 may comprise picture-capturing circuitry that digitally captures images, converts the images into digital data, and temporarily stores the digital image data in RAM. In this same example, the digital camera may further comprise an LCD for displaying previously captured images that are reproduced from data retrieved from memory 106. The user device processing system 300 comprises a plurality of input/output (I/O) terminals for transmitting or receiving data. In a standard transfer mode, data is transferred along a SLOW DATA bus 302 between the user device processing system 300 and a standard transfer circuit 304. In a fast serial transfer mode, data is transferred along a FAST DATA bus 305 between the user device processing system 300 and a fast serial transfer circuit 306. Additional parallel branches may be connected within the host if additional transfer modes are desired.

The standard transfer circuit 304 contains electrical circuitry for performing the transfer of data in a standard transfer mode. The standard transfer circuit 304 is configured to transfer parallel data from bus 302 to lines 308 during a data writing procedure and to transfer parallel data from lines 308 to bus 302 during a data reading procedure. A significant operation performed by the standard transfer circuit 304 is to format the data from the slow data bus 302 to the width supported by the lines 308. Other functions can include wrapping the data to be transmitted with a Cyclical Redundancy Check (CRC) and decoding the CRC on the received data.

The fast serial transfer circuit 306 contains electrical circuitry that is capable of transferring data using a high-speed differential serial transfer protocol. The fast serial transfer circuit 306 may be capable of transferring data at a rate of at least 100 MB per second. With such a transfer rate, large files may be downloaded in less than a second, as opposed to prior art download times of several minutes.

The fast serial transfer circuit 306 receives a system clock signal CLK from host control logic circuitry 318 and multiplies the clock frequency up to a “fast clock” speed using a phase locked loop (PLL) circuit. The fast serial transfer circuit 306 further comprises buffers for temporarily holding data during the transfer of data between the user device processing system 300 and the fast serial transfer circuit 306. The fast serial transfer circuit 306 preferably comprises error detection and correction circuitry, synchronization detecting circuitry, an eight bit to ten bit encoder, and a ten bit to eight bit decoder to facilitate encoding of clock and data, to allow separation of clock and data, and to facilitate decoding of data. A serial/deserial circuit, which converts serial data to parallel and converts parallel data to serial, is preferably included within the fast serial transfer circuit 306.

During a data-writing command, the fast serial transfer circuit 306 sends an upconverted fast clock (FAST CLK) signal to the user device processing system 300. When the user device processing system 300 receives the FAST CLK signal, the fast serial transfer circuit 306 draws serial data from the user device processing system 300 along the FAST DATA bus 305 at the fast clock speed.

Furthermore, the fast serial transfer circuit 306 comprises two differential amplifiers that transmit and receive data along lines 310. A transmitting differential amplifier converts digital data to a serial differential format, wherein the serial differential data is transmitted along a positive transmit line (DT+) and a negative transmit line (DT−). A receiving differential amplifier receives serial differential data from a positive receive line (DR+) and a negative receive line (DR−) and converts the serial differential data to the digital format. In addition to the DT and DR lines, a BUSY line may be added in order to provide a signal from the memory controller 104 when the memory controller 104 is busy and not ready to receive more data. The BUSY line may also be used to communicate that an error has occurred. If the fast serial transfer circuit 306 receives a BUSY signal, the transfer of data is stopped until the memory controller 104 is again ready to receive. The BUSY line remaining busy for a predetermined amount of time may be indicative of an error.

A switching circuit 312 is connected to lines 308 that lead to the standard transfer circuit 304 and to lines 310 that lead to the fast serial transfer circuit 306. Lines 310 are labeled “DT+,” “DT−,” “DR+,” and “DR−,” wherein “DT” represents data transmitted from the fast serial transfer circuit 306 and “DR” represents data received by the fast serial transfer circuit 306. The switching circuit 312 comprises a number of internal switching elements that allow separate paths of data transfer to be selected. Data may be transferred through the switching circuit 312 in a fast serial transfer mode or in a standard transfer mode. The host 102 may be configured to power up in the standard transfer mode and switch to the fast serial transfer mode upon demand. In the fast serial transfer mode, the switching elements of the switching circuit 312 are configured such that lines 314, connected to an output of the switching circuit 312, are electrically coupled to lines 310, leading to the fast serial transfer circuit 306. In the standard transfer mode, the switching elements are configured such that lines 314 are electrically coupled to lines 308, leading to the standard transfer circuit 304.

Lines 314 are connected between the switching circuit 312 and a connector 316. The connector 316 comprises the physical characteristics to allow proper connection with whichever type of memory card 200 is used. The connector 316 comprises both output terminals and I/O terminals, which are connected to interface lines 204. The CLK, V_{dd}, and GND terminals are typically configured as output terminals for providing the system clock signal and the power and ground voltages along the respective interface lines 204. These outputs are typically generated by the host control logic circuitry 318 of the host 102.

In addition, the connector 316 includes I/O terminals, such as data terminals D1, D2, . . . , DN, which transmit and receive data. A command terminal (CMD) may be configured as an I/O terminal for transmitting and receiving commands between the host 102 and the memory controller 104. The CMD terminal receives responses from the memory controller 104 notifying the host 102 of the status of the commands. For example, the memory controller 104 may return a signal to the host 102 along the CMD line to indicate whether or not a command from the host 102 was properly received. If an error was detected in the transmitting of the command, the memory controller 104 may send an error response with an error code indicating the type of error detected.

The components of the host 102 shown in FIG. 3 are controlled by the host control logic circuitry 318. The host control logic circuitry 318 provides control signals to the user device processing system 300, standard transfer circuit 304, fast serial transfer circuit 306, and switching circuit 312. The host control logic circuitry 318 provides signals to the various circuits in order to select either the fast serial transfer mode or the standard transfer mode. The host 102 may optionally comprise additional transfer circuits to be selected if more transfer modes are desired.

Furthermore, the host control logic circuitry 318 may comprise circuitry or software that is capable of determining when the standard transfer mode is not sufficiently fast enough to handle large amounts of data to be transferred, and may thereby switch to the fast serial transfer mode. Alternatively, the host control logic circuitry 318 may receive a user input requesting the fast serial transfer mode, when the user anticipates the need for a quicker transfer rate. The host control logic circuitry 318 sends a signal to either the fast serial transfer circuit 306 or the standard transfer circuit 304 in order to enable the proper circuit for operation in the selected mode. The host control logic circuitry 318 further signals the switching circuit 312 to configure the switching elements appropriately. In addition, the host control logic circuitry 318 comprises an oscillator, or other type of clocking device, for providing a reference clock signal that is used as the system clock. The host control logic circuitry 318 further provides command signals to the memory controller 104 along a CMD line.

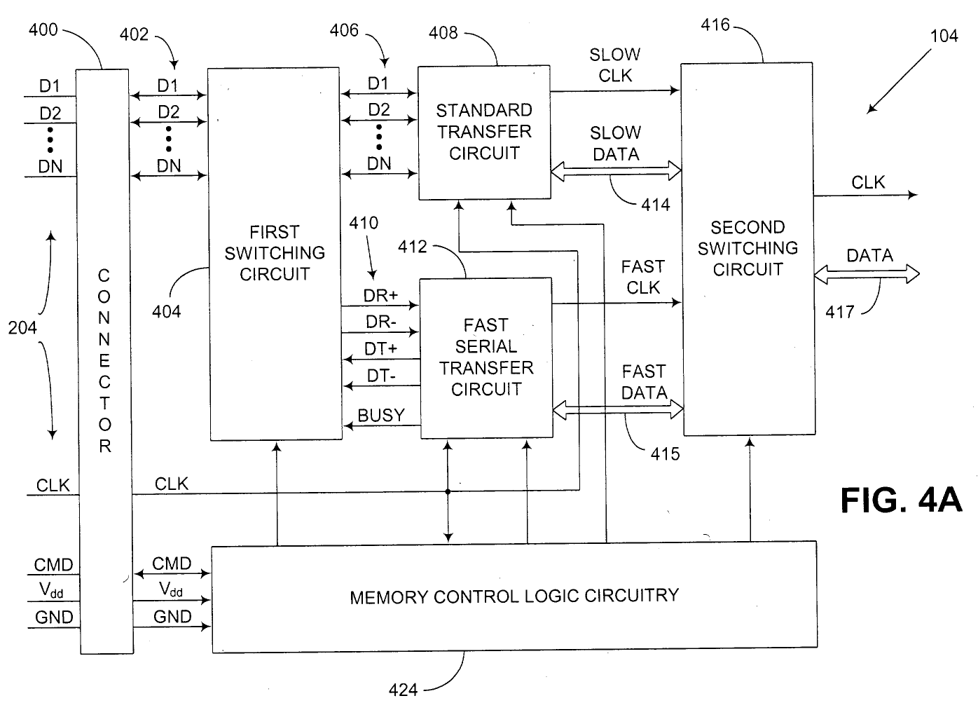

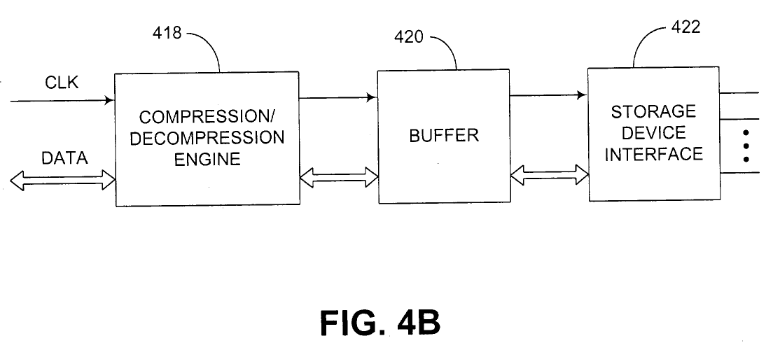

With reference to FIGS. 4A and 4B, an embodiment of the memory controller 104 is shown. The components of the memory controller 104 may be manufactured together as one application specific integrated circuit (ASIC) if desired. The D1, D2, . . . , DN, CLK, CMD, V_{dd}, and GND interface lines 204 are removably connected between the connector 316 of the host 102, as described above, and a connector 400 of the memory controller 104. The connector 400 is configured such that it is compatible with the connector 316. In other words, the location of the contacts of the connector 400 conforms to the shape and location of the contacts within a receptacle (not shown) of the connector 316. When the memory card 200 is inserted in the receptacle, the contacts of the connector 400 are electrically coupled to the contacts of the connector 316. The connector 400 is configured according to the form factor of the particular memory card system being used. Data that is created in the host 102 may be transmitted to the memory card 200 via the connectors. When the host 102 retrieves data from the memory banks 202, the data is transmitted from the memory card 200 to the host 102 via the connectors.

The memory controller 104 further comprises a first switching circuit 404, which may be configured in the same way as the switching circuit 312 of the host 102. The first switching circuit 404 of the memory controller 104 receives and transmits data along lines 402, connected between the connector 400 and the first switching circuit 404. The first switching circuit 404 comprises switching elements that allow the lines 402 to be coupled to lines 406, which are connected between the first switching circuit 404 and a standard transfer circuit 408, or to lines 410, which are connected between the first switching circuit 404 and a fast serial transfer circuit 412. Lines 410 are labeled “DR+,” “DR−,” “DT+,” and “DT−,” wherein “DR” represents data received from the host 102 and “DT” represents data transmitted to the host 102. The “+” and “−” symbols represent the positive and negative lines that are used in the serial differential scheme as mentioned above. The memory controller's standard transfer circuit 408 and fast serial transfer circuit 412 may comprise circuitry similar to the host's standard transfer circuit 304 and fast serial transfer circuit 306, respectively. Likewise, the standard transfer circuit 408 and fast serial transfer circuit 412 perform substantially the same function as circuits 304 and 306.

A SLOW DATA bus 414 is connected to I/O terminals of the standard transfer circuit 408. A FAST DATA bus 415 is connected to I/O terminals of the fast serial transfer circuit 412. Buses 414 and 415 are also connected to a second switching circuit 416, which acts in conjunction with the first switching circuit 404 to connect either the standard transfer circuit 408 or the fast serial transfer circuit 412 into the data transfer path. Data is transferred along data bus 417 to a compression/decompression engine 418, which comprises circuitry for compressing data during a data writing command. The switching circuits and the various data transfer paths do not rely upon the operation of the compression/decompression engine 418 to perform the data path switching procedures. Likewise, the compression/decompression engine 418 does not rely upon the operation of the data path-switching configuration to perform the compression and decompression procedures. Therefore, the compression/decompression engine 418 may be an optional feature added to the data storage system 100 disclosed herein. During a data-reading command, the compression/decompression engine 418 utilizes decompression circuitry to decompress any data that has been compressed using an algorithm known to the decompression circuitry. The fast data transfer speed of the switching arrangement may be enhanced by the compression/decompression engine 418, allowing slower media to accept data at the same high-speed rate. Since the compression/decompression engine 418 sends less information to memory 106 for storage, the compressed data may be stored much faster than data that is not compressed. Another benefit of adding compression functionality to the memory controller 104 is that less storage space is required in memory, allowing the user to store more data. By compressing data during the writing of data into memory 106, the data takes up less storage space in memory 106. Therefore, the storage capacity of memory 106 may effectively be increased due to this compression of data.

The compressed data is transferred between the compression/decompression engine 418 and a buffer 420, which is capable of handling data at the fast transfer rate. During a writing command, the buffer 420 sends data to a storage device interface 422, which includes circuitry that is capable of organizing the compressed data for quick storage. The storage device interface 422 may comprise a sequencer for distributing the serial data among a plurality of paths leading to the plurality of memory banks 202. Preferably, the storage device interface 422 comprises additional buffers for temporarily holding the compressed data as it is being transferred to the memory banks 202. The storage device interface 422 further comprises error correction code (ECC) circuitry for adding parity to the compressed data, which, when read back from memory 106, allows for the detection and correction of errors. The order of the compression/decompression engine 418 and the storage device interface 422 may be reversed. In such a case, the compression of data is the last function performed before storing the data in the memory banks 202 and the decompression of data is the first function performed when data is read from the memory banks 202.

The memory controller 104 of FIGS. 4A and 4B further comprises memory control logic circuitry 424 that provides control functionality for the memory controller 104. The memory control logic circuitry 424 receives commands from the host 102 along the CMD line and provides signals to the appropriate circuits for carrying out the requested command. If an error occurs in the reception of the command from the host 102, the memory control logic circuitry 424 returns an error code back to the host 102 over the CMD line to inform the host 102 of the error. The CLK line provides the system clock signal to the memory control logic circuitry 424 for synchronizing the memory controller 104 with the host 102.

The memory control logic circuitry 424 provides signals to the first switching circuit 404, standard transfer circuit 408, fast serial transfer circuit 412, and second switching circuit 416 to select between the standard transfer mode and the fast serial transfer mode. The data transfer path goes through the fast serial transfer circuit 412 when the fast serial transfer mode is selected and goes through the standard transfer circuit 408 when the standard transfer mode is selected. The memory control logic circuitry 424 enables the appropriate transfer circuit 408 or 412 and initiates the corresponding configuration in the switching circuits 404 and 416.

The components of the data storage system 100 can be implemented in hardware, software, firmware, or a combination thereof. In the disclosed embodiments, the host control logic circuitry 318 and memory control logic circuitry 424 may be implemented in software or firmware that is stored in a memory and that is executed by a suitable instruction execution system. If implemented in hardware, as in an alternative embodiment, the processors can be implemented with any or a combination of the following technologies, which are all well known in the art: a discrete logic circuit having logic gates for implementing logic functions upon data signals, an ASIC having appropriate combinational logic gates, a programmable gate array (PGA), a field programmable gate array (FPGA), etc.

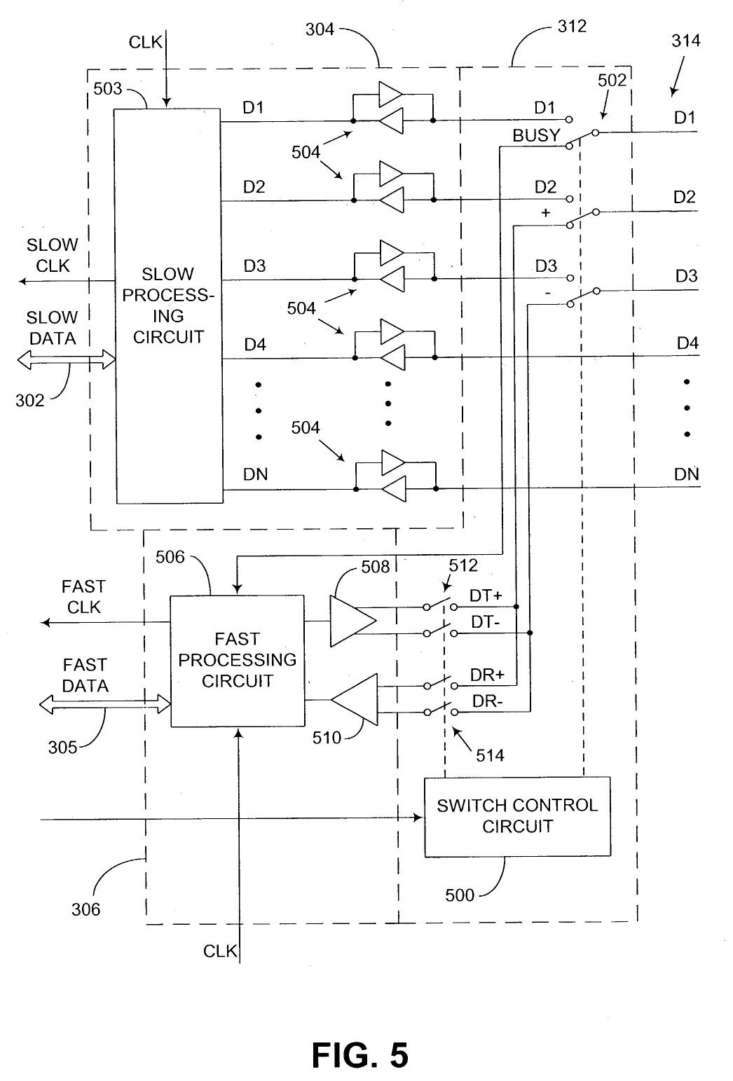

In general, embodiments of the host 102 and memory controller 104 may be configured as illustrated in FIGS. 3, 4A, and 4B, as described above. The general components of the host 102 and memory controller 104 having been described, reference is now made to FIGS. 5-11, which further define the individual components of the host 102 and memory controller 104. It should be noted that alternative embodiments for the following components may be realized by one of skill in the art having a clear understanding of the present disclosure.

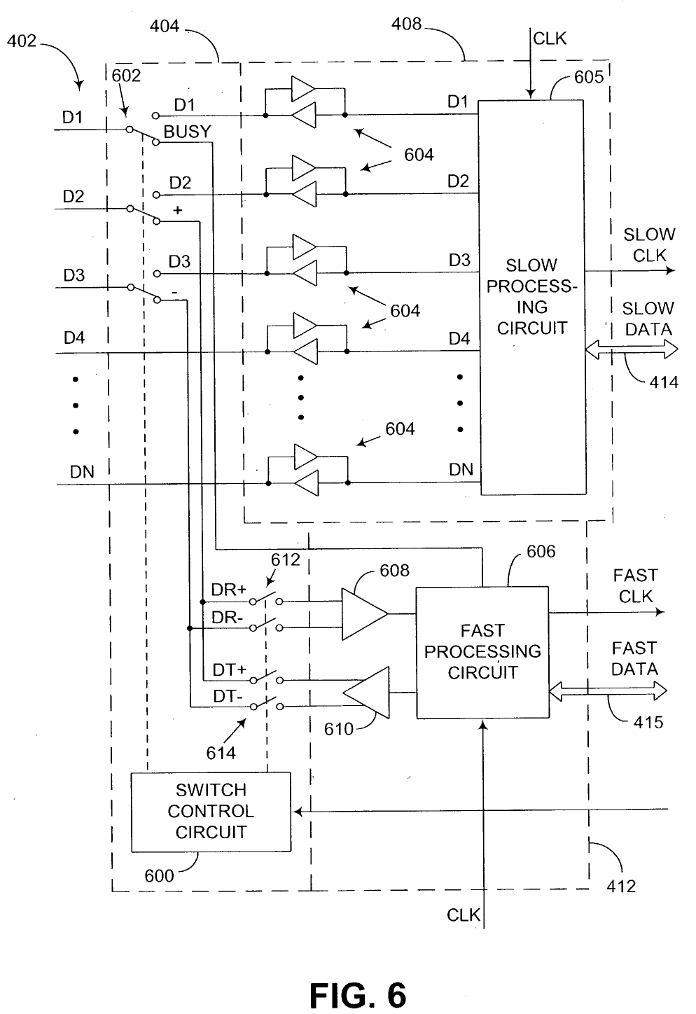

FIGS. 5 and 6 represent embodiments of portions of the host 102 and the memory controller 104, respectively, when the data storage system 100 is configured to operate in a half-duplex mode. FIG. 5 illustrates a portion of the host 102 that makes up the switching arrangement, comprising details of the standard transfer circuit 304, the fast serial transfer circuit 306, and the switching circuit 312. The outputs from the fast serial transfer circuit 306 are connected in the switching circuit 312 in a half-duplex arrangement, wherein the DT+ and DR+ lines share a positive terminal and the DT− and DR− lines share a negative terminal.

The switching circuit 312 comprises a switch control circuit 500 that receives a signal from the host control logic circuitry 318 indicating the data transfer mode in which the data storage device 100 is to be operating. Once the switch control circuit 500 has received a command from the host control logic circuitry 318, the switch control circuit 500 maintains the desired mode. Therefore, the host control logic circuitry 318 must only initiate the request once and the switch control circuit 500 holds the desired state until it is reprogrammed to another state. The switch control circuit 500 may comprise a register, which holds the desired state. The switch control circuit 500 provides constant signals to a plurality of switches 502 and holds the switches 502 in the desired state until a different state is requested.

When the standard transfer mode is requested, the switch control circuit 500 configures switches 502 in a state such that the data lines D1, D2, . . . , DN, which pass through the standard transfer circuit 304, are electrically connected to the lines 314 that lead to the connector 316. In the standard transfer circuit 304, data along SLOW DATA bus 302 is input into a slow processing circuit 503 where the parallel or serial lines are converted to a format having a number N of data lines D1, D2, . . . , DN. The data lines D1, D2, . . . , DN are connected to push-pull transceivers 504. The push-pull transceivers 504 comprise driving amplifiers for driving data signals in one direction or the other. The push-pull transceivers 504 along data lines D1, D2, . . . , DN are further connected to a first set of contacts on one side of switches 502. When switched in the standard transfer mode, the SLOW DATA bus 302 is connected to the data lines 314 via the push-pull transceivers 504.

In the fast serial transfer mode, the switch control circuit 500 configures switches 502 in an alternative state such that the positive and negative lines from the fast serial transfer circuit 306 are connected to lines D2 and D3 of data lines 314. The positive portion of the serial differential signal is connected to data line D2 and the negative portion is connected to D3. A BUSY line is connected to data line D1 and receives a signal from the memory controller 104 when the memory controller 104 is busy and not ready to receive more data. In response to a busy signal, the host 102 waits to send additional data until the memory controller 104 sends a “not busy” signal. The remaining data lines D4, D5, . . . , DN are not used in the half-duplex fast serial transfer mode. Although FIG. 5 illustrates the use of data lines D1, D2, and D3 in the arrangement shown, the host may be configured such that any three arbitrary data lines are used for the BUSY, positive, and negative lines. The determination of which data lines to use may be based on the physical characteristics of the host 102.

A second set of contacts of switches 502, comprising the BUSY, positive, and negative terminals, are connected to differential amplifiers 508 and 510 via switch pairs 512 and 514, respectively. The switch control circuit 500 may close the switch pair 512 when data is transmitted, or, in other words, when data from the host 102 is to be written to memory 106 through the memory controller 104. When the switch control circuit 500 closes the switch pair 512, DT+ is connected to the D2 line and DT− is connected to the D3 line. When reading data from memory 106, the switch control circuit 500 closes switch pair 514, to connect the DR+ and DR− lines to D2 and D3. The differential amplifiers 508 and 510 are connected to a fast processing circuit 506. The fast processing circuit 506 comprises a phase locked loop (PLL) circuit that receives the clock signal from the CLK line and synchronizes its internal clock to the reference clock signal. Furthermore, the PLL circuit multiplies the clock frequency for use in the fast serial transfer mode. The fast processing circuit 506 further comprises a serial/deserial circuit that converts data from an eight-bit parallel format, for example, to a serial format, or vice versa. Both data signals and clock signals are embedded in a data stream for the transmission of data in the fast serial transfer mode.

During a data writing command, switch pair 512 is closed and the fast processing circuit 506 serially transmits data through differential amplifier 508, which outputs differential data along data lines D2 and D3. During a read command, switch pair 514 is closed and the differential amplifier 510 receives differential data from data lines D2 and D3 and sends digital data to the fast processing circuit 506.

The switches 502 and switch pairs 512 and 514 may be comprised of any type of electrical or transistor-based device in silicon or otherwise that provides alternative connections between a first contact and a plurality of selectable contacts or that provides alternative open or closed states. The alternative connection configurations of the switches 502 provide alternative paths from the group of data lines 314 to multiple sets of lines, e.g. lines 302 or the DT and DR lines.

Optionally, the data storage system 100 may be configured, as described above, such that the host 102 and the memory controller 104 comprise more than two selectable paths. Additional paths and transfer circuits may be added, allowing the selection of additional data transfer modes. In the embodiment where additional paths are included, the switches 502 may be configured having additional terminals such that lines 314 may be connected along other paths through additional transfer circuits.

FIG. 6 is a block diagram of an embodiment of the switching portion of the memory controller 104, which is designed to operate in conjunction with the half-duplex arrangement of the host 102 shown in FIG. 5. The memory controller's first switching circuit 404 may be substantially the same as the host's switching circuit 312. A switch control circuit 600 receives a command from the memory control logic circuitry 424 to switch to the desired data transfer mode. Preferably, the switch control circuits 500 and 600 are synchronized so that the transfer mode is consistent on both sides. To maintain synchronization in this regard, the host control logic circuitry 318 sends a command along the CMD line to the memory control logic circuitry 424 instructing the memory controller processor 424 to prompt the switch control circuit 600 to switch to the requested data transfer mode. The switch control circuit 600 maintains a constant signal at switches 602 to hold the switches 602 in the desired state. In the fast serial transfer mode, the data lines 402 are electrically coupled to the DR and DT lines. In the standard transfer mode, the data lines 402 are coupled to the SLOW DATA bus 414 via the standard transfer circuit 408.

Push-pull transceivers 604 and a slow processing circuit 605 are connected between data lines 402 and the SLOW DATA bus 414 in the standard transfer circuit 408. One terminal of each of the switches 602 is connected to switch pairs 612 and 614. Switch pair 612 connects lines D2 and D3 of data lines 402 to differential amplifier 608. During a data writing command in the fast serial transfer mode, switch pair 612 is closed and the differential signals along lines DR+ and DR− are input into the differential amplifier 608, which provides a signal to the input of a fast processing circuit 606. During a data reading command in the fast serial transfer mode, the switch control circuit 600 closes switch pair 614 and the fast processing circuit 606 provides an output signal to a second differential amplifier 610. The differential amplifier 610 transmits serial differential outputs along the DT+ and DT− lines to lines D2 and D3 of the data lines 402.

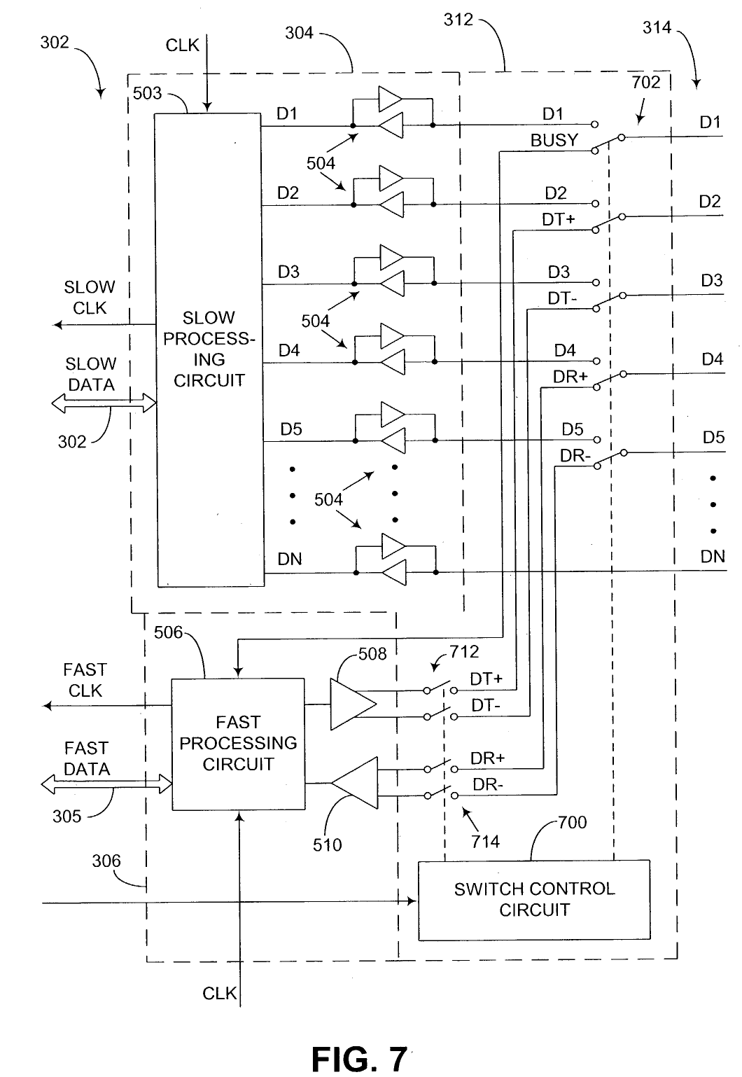

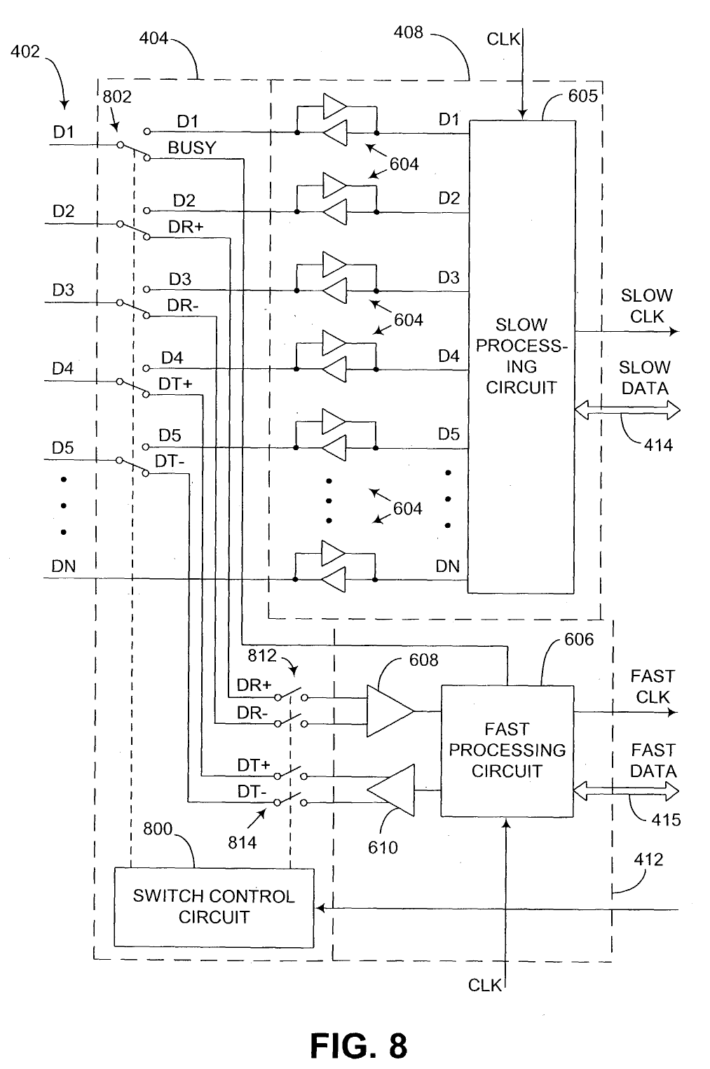

FIGS. 5 and 6, described above, illustrate an example of a half-duplex arrangement. As an alternative to the half-duplex arrangement, FIGS. 7 and 8 provide an embodiment of the host 102 and memory controller 104 in a full-duplex mode. The main difference between the two sets of figures is that, in the half-duplex arrangement of FIGS. 5 and 6, the positive lines DT+ and DR+ share a common positive terminal and the negative lines DT− and DR− share a common negative terminal. Therefore, in FIGS. 5 and 6, data is either transmitted or received on the same data lines D2 and D3. Differential serial data is transferred along data lines D2 and D3 in one direction or the other. In FIGS. 7 and 8, the four outputs from the differential amplifiers 508, 510, 608, and 610 are connected to four data lines D2, D3, D4, and D5. As mentioned above, any of the data lines D1, D2, . . . , DN may be arbitrarily selected as the specific data lines for the transfer of the DT+, DT−, DR+, and DR− signals. With the use of the two additional data lines, a serial differential signal can be transmitted along two data lines and another serial differential signal can be simultaneously received along two different data lines.

In FIG. 7, showing the host 102 in the full-duplex mode, a switch control circuit 700 configures five switches 702 based on a request for operation of the data storage system 100 in the standard transfer mode or the fast serial transfer mode. Compared to the half-duplex mode of FIG. 5, FIG. 7 shows two addition switches 702 added between the data lines 314 and the alternate paths through the standard transfer circuit 304 and fast serial transfer circuit 306. In the fast serial transfer mode, the switch control circuit 700 configures the switches 702 as shown in FIG. 7 such that lines D1, D2, D3, D4, and D5 are connected to the BUSY line and data terminals DT+, DT−, DR+, and DR−, respectively. The switch control circuit 700 closes switch pair 712 during a writing command and closes switch pair 714 during a reading command. Switch pairs 712 and 714 may be optional in the full-duplex mode since transmission and reception may be simultaneous. For this reason, the switch pairs 712 and 714 may be removed or replaced with a flow-through connection.

FIG. 8 illustrates the memory controller 104 in the full-duplex arrangement and operates in conjunction with the full-duplex arrangement of the host 102 shown in FIG. 7. FIG. 8 is similar to FIG. 6 except that a switch control circuit 800 configures five switches 802 instead of three. Differential amplifiers 608 and 610 are connected to data lines D2, D3, D4, and D5 in the full-duplex mode, instead of only two data lines as in the half-duplex mode. These connections are made through switch pairs 812 and 814, which again may be optional in the full-duplex mode.

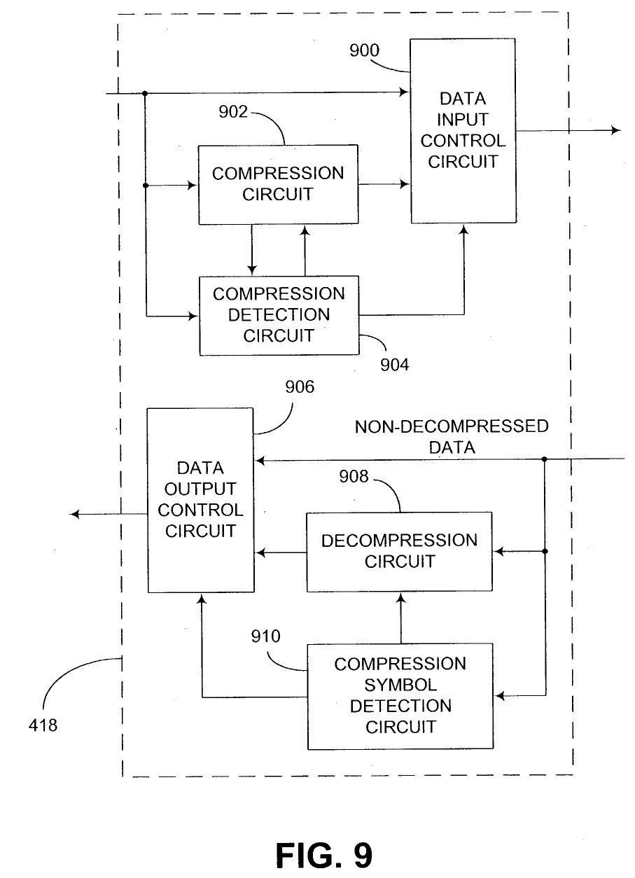

FIG. 9 illustrates an embodiment of the compression/decompression engine 418. In a data writing mode, incoming data to the compression/decompression engine 418 travels to a data input control circuit 900, a compression circuit 902, and a compression detection circuit 904. The compression circuit 902 compresses the incoming data and sends the compressed data to the data input control circuit 900 and to the compression detection circuit 904. The compression detection circuit 904, having received the incoming data and the data compressed by the compression circuit 902, compares the two and determines if the incoming data has already been compressed, previous to the compression by the compression circuit 902. The compression detection circuit 904 may make this determination based on the fact that when the compression circuit 902 compresses data that has already been compressed, then the algorithm used by the compression circuit 902 to compress data may actually expand the data. Therefore, if the data is not capable of further compression or if the data is expanded by the compression circuit 902 instead of being compressed, then the compression detection circuit 904 determines that the data has already been compressed.

The compression detection circuit 904 sends a signal to the data input control circuit 900 instructing the data input control circuit 900 to choose between either the incoming data or the compressed data from the compression circuit 902. The compression detection circuit 904 may send an additional signal to the compression circuit 902 to inform the compression circuit 902 that the compression algorithm used is not effective. Consequently, the compression circuit 902, when notified of the ineffective algorithm, may switch to a different algorithm. The compression detection circuit 904 notifies the data input control circuit 900 whether or not the incoming data has already been compressed. If the incoming data has already been compressed, then the data input control circuit 900 ignores the data from the compression circuit 902 and selects the already-compressed incoming data. If the incoming data has not been previously compressed, the data input control circuit 900 ignores the incoming data and selects the compressed data from the compression circuit 902. The data input control circuit 900 transfers the selected data along with a compression indication symbol that may indicate whether the transferred data is the compressed data from the compression circuit 902 or the previously-compressed incoming data. The compression indication symbol may additionally comprise information concerning the type of algorithm that the compression circuit 902 used to compress the incoming data.

When data is read from memory 106, the data is input into the decompression portion of the compression/decompression engine 418. Stored data goes to a data output control circuit 906, a decompression circuit 908, and a compression symbol detection circuit 910. The compression symbol detection circuit 910 detects the compression indication symbol to determine whether or not the compression detection circuit 904 compressed the stored data and, if so, the algorithm that was used. When the compression symbol detection circuit 910 determines how the stored data was compressed, the compression symbol detection circuit 910 sends a signal to the decompression circuit 908 to instruct the decompression circuit 908 how to decompress the stored data. The compression symbol detection circuit 910 further notifies the data output control circuit 906 whether or not the stored data was compressed by a known compression algorithm in the compression circuit 902. In response, the data output control circuit 906 selects either the non-decompressed data or the data decompressed by the decompression circuit 908. The data output control circuit 906 transfers the selected data to the output of the compression/decompression engine 418.

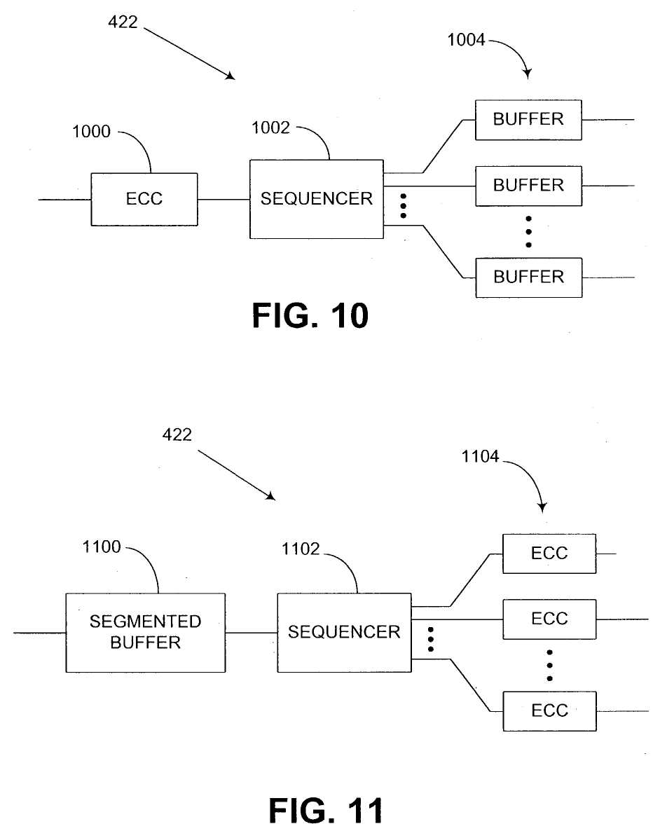

FIGS. 10 and II illustrate two example embodiments of the storage device interface 422, which acts as an interface between the compression/decompression engine 418 of the memory controller 104 and the memory banks 202, as shown in FIG. 4. In a writing command, the storage device interface 422 transfers blocks of data to the memory banks 202, and in a reading command, the storage device interface 422 retrieves blocks of data from the memory banks 202. In the embodiment of FIG. 10, the storage device interface 422 transfers serial data from the buffer 420 to a high-speed ECC circuit 1000. The ECC circuit 1000 is connected to a high-speed sequencer 1002, which sends data along a number of branches along paths to a corresponding number of buffers 1004. During a data writing command, the ECC circuit 1000 receives data from the buffer 420 and adds parity bits to the data. When reading the data from the memory banks 202, the ECC circuit 1000 detects the data for errors and corrects any correctable errors in the data and then removes the parity bits and sends the corrected data back to the buffer 420.

During the data writing command, the high-speed sequencer 1002 separates the serial data from the ECC circuit 1000 into multiple parallel paths. The number of paths may be four, for example, or any number such that the transfer rate of each buffer 1004 times the number of buffers is sufficient to maintain the transfer of data at the high speed during the fast serial transfer mode. Buffers 1004 temporarily store the data along the paths separated by the sequencer 1002, forms the data into blocks, and transfer the data blocks into corresponding memory banks 202. It should be noted that when the data storage system 100 is in the standard transfer mode, all but one of the buffers 1004 may be idle when not in use. In this case, power savings may be realized due to the use of only one buffer 1004 at a time.

FIG. 11 illustrates an alternative embodiment of the storage device interface 422, wherein, during a data writing command, a high-speed segmented buffer 1100 receives serial data and transfers the data to a high-speed sequencer 1102, which divides the data into separate blocks along a number of separate paths. Each block of data is input into a respective ECC circuit 1104, which adds parity to the data. The data blocks, with the added parity, are stored in memory banks 202. During a data read command, the ECC circuits 1104 retrieve data blocks from the different memory banks 202, detects any existing errors, corrects the errors, removes the parity bits, and sends the data blocks to the sequencer 1 102, which then pieces the blocks back together and serially transmits the data back to the segmented buffer 1100.

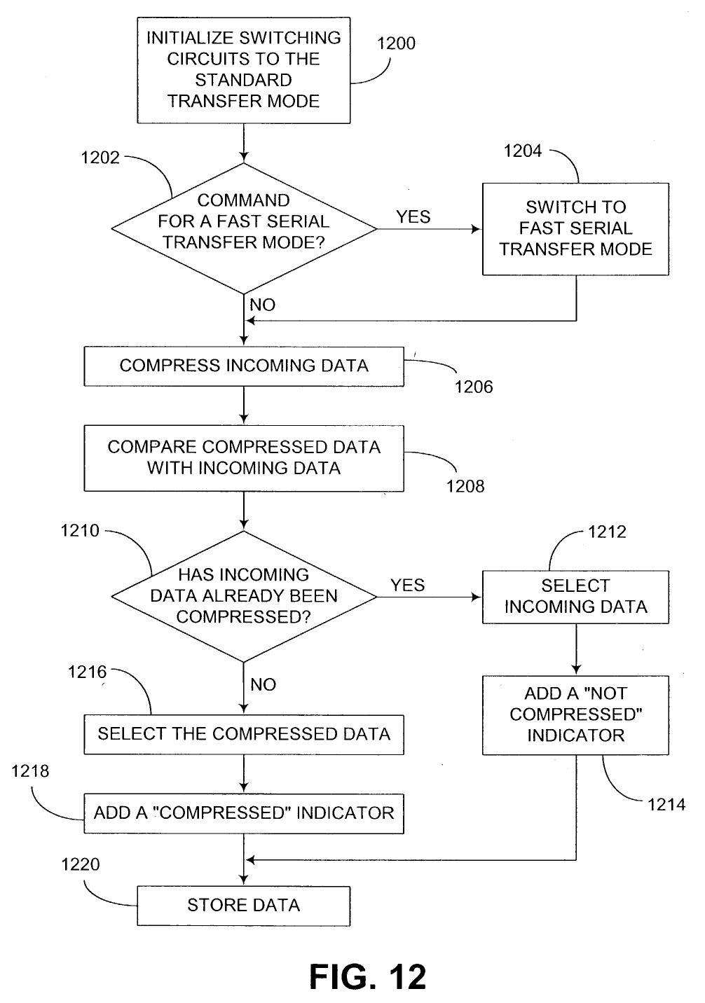

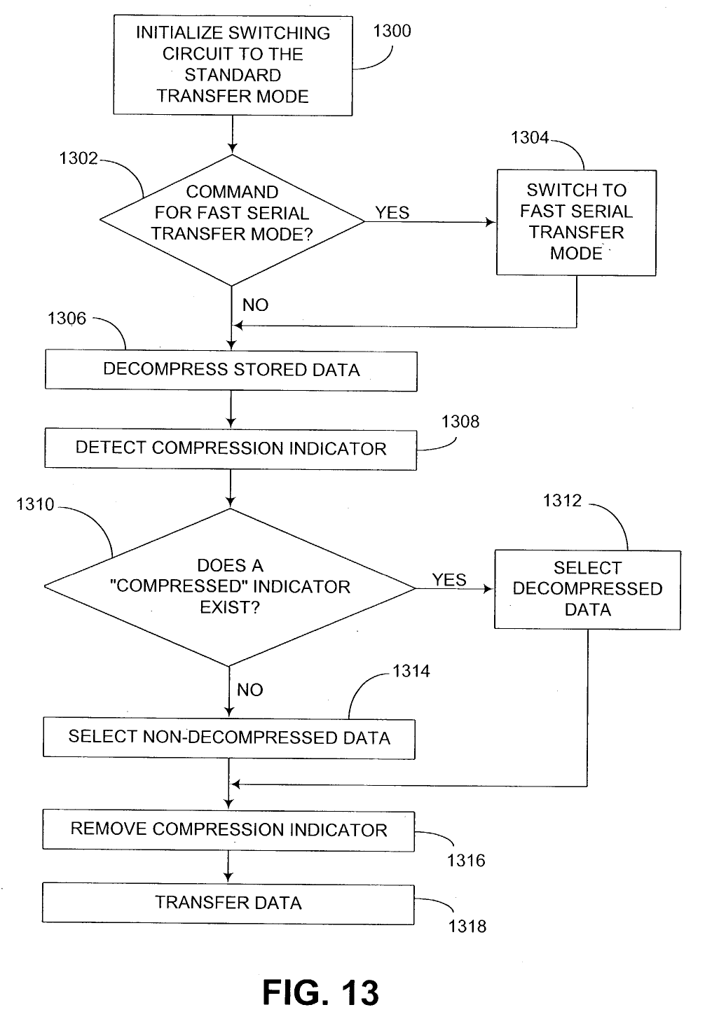

Reference is now made to the methods of operating the data storage system 100, described in detail above with respect to FIGS. 1-11. FIG. 12 illustrates an example embodiment of a data writing command, wherein data that is created in the host 102 is written into memory 106. FIG. 13 illustrates an example embodiment of a data reading command, requested by the host 102, for reading data from memory 106.

FIG. 12 illustrates a data-writing command, which is typically initiated by the host 102. The first step involves initializing the switching circuits to the standard transfer mode, as indicated in block 1200. As shown in decision block 1202, a step of determining whether or not the host 102 has requested the fast serial transfer mode is performed. If the fast serial transfer mode is requested, the step indicated in block 1204 is performed. The host control logic circuitry 318 and memory control logic circuitry 424 send signals to the switch control circuits 500, 600, 700, 800 of the switching circuits 312 and 404. The switch control circuits 500, 600, 700, 800 configure the switches 502, 602, 702, 802 to a state that allows the transfer of data in the fast serial transfer mode. If no command for the fast serial transfer mode has been made, then flow proceeds to block 1206. It should be understood that the standard transfer mode may be a default mode, wherein the data storage system 100 remains in this mode at all times unless the fast serial transfer mode has been specifically requested. However, the data storage system 100 may be configured in the opposite manner such that the fast serial transfer mode is the default mode. In embodiments wherein more than two transfer modes are available, the decision block 1202 may comprise a selection step for selecting among a number of different transfer modes.

The data writing method may end at this point, wherein the host 102 and the memory controller 104 write data into memory 106 in either one of the two or more data transfer modes. When the memory controller 104 is configured with the compression/decompression engine 418, the remaining steps of FIG. 12 may be performed in the data writing method.

In block 1206, the compression circuit 902 compresses the data coming into the compression/decompression engine 418. Then, the compression detection circuit 904 compares the incoming data with the compressed data output from the compression circuit 902, as indicated in block 1208. The compression detection circuit 904 uses this comparison to determine whether or not the incoming data was compressed prior to the compression by the compression circuit 902. Decision block 1210 indicates the step of determining whether the incoming data was already compression, and, if so, controls the flow of steps to step 1212. In this step, the compression detecting circuit 904 signals the data input control circuit 900 to select the incoming data and not the compressed data. The data input control circuit 900 selects the incoming data and further adds a compression indication that indicates the current data being stored in memory 106 is “not compressed,” as indicated in block 1214.

If the compression detection circuit 904 determines in decision block 1210 that the incoming data was not already compressed prior to the compressing of data by the compression circuit 902, then the method flow proceeds to block 1216. In this step, the compression detection circuit 904 signals the data input control circuit 900 that the incoming data was not previously compressed and that the newly compressed data is to be selected. The data input control circuit 900 selects the compressed data from the compression circuit 902 and adds a compression indicator (block 1218) that flags the present data written into memory 106 as “compressed” data. After the selecting steps of blocks 1212 and 1216 and the compression indication adding steps of blocks 1214 and 1218, flow proceeds to block 1220 where the selected data and corresponding compression indicator are stored into memory 106.

FIG. 13 illustrates an embodiment of a data reading method. Blocks 1306, 1308, 1310, 1312, 1314, and 1316 refer to steps involved in the portion of the data reading method involving decompression. When the data storage system 100 comprises a compression/decompression engine 418, then these steps may be followed. When the data storage system 100 does not include compression and decompression, then these steps may be skipped. Furthermore, when the data storage system 100 comprises the switching arrangement including the switching circuits 312, 404, and 416, the standard transfer circuits 304 and 408, and the fast serial transfer circuits 306 and 412, then the steps shown in blocks 1300, 1302, and 1304 may be followed. When the data storage system 100 does not comprise the switching arrangement, then these steps may be skipped. Therefore, the compression and decompression steps may be considered to be separate from the data transfer mode switching steps. As an alternative embodiment, the steps of the compression and decompression may be reversed with the steps of the data transfer mode switching steps when the data storage system 100 comprises an embodiment wherein the switching arrangement is located between memory 106 and the compression/decompression engine 418.

FIG. 13 illustrates the steps involved in the switching between the different transfer modes. In block 1300, the switching circuits are initialized to the standard transfer mode. The host control logic circuitry 318 and memory control logic circuitry 424 signal the corresponding switch control circuits 500, 600, 700, or 800 to configure the switches 502, 602, 702, and 802 and switch pairs 512, 514, 612, 614, 712, 714, 812, and 814 such that the standard transfer circuits 304 and 408 are coupled into the data transfer path. In decision block 1302, the data storage system 100 determines whether or not a command has been made to operate in the fast serial transfer mode. If decision block 1302 determines that the fast serial transfer mode has been requested, then flow proceeds to block 1304 where the data storage system 100 configures the switches and switch pairs such that the fast serial transfer circuits 306 and 412 are coupled into the data transfer path. Once the data transfer mode has been established and the proper transfer circuit has been switched into the data transfer path, the data may be further decompressed if necessary.

The embodiment shown in FIG. 13 further comprises a step wherein the decompression circuit 908 decompresses the stored data from memory 106, as indicated in block 1306. In block 1308, the compression symbol detection circuit 910 detects the compression indicator that accompanies the stored data. In decision block 1310, the compression symbol detection circuit 910 further determines whether or not the compression indicator is the “compressed” indicator. If so, the flow of steps proceeds to block 1312 where the compression symbol detection circuit 910 signals the data output control circuit 906 that the decompressed data from the decompression circuit 908 is to be selected. In response, the data output control circuit 906 selects the decompressed data. Steps 1310 and 1312 may further include steps of detecting the type of compression algorithm used during the compression of data and the prompting to the decompression circuit 908 to decompress the data according to the type of compression algorithm used. If decision block 1310 determines that a “not compressed” indicator exists, then the flow proceeds to block 1314 where the compression symbol detection circuit 910 signals the data output control circuit 906 to select the non-decompressed data directly from memory 106 as opposed to the decompressed data from the decompression circuit 908. At this point, the data output control circuit 906, having selected the appropriate set of data, removes the compression indicator that was added during compression, as indicated in block 1316, and the data is transferred to the host 102 (block 1318).

The flow charts of FIGS. 12 and 13 show the architecture, functionality, and operation of possible implementations of the data writing and data reading software. In this regard, each block represents a module, segment, or portion of code, which comprises one or more executable instructions for implementing the specified logical function(s). It should also be noted that in some alternative implementations, the functions noted in the blocks may occur out of the order noted in FIGS. 12 and 13. For example, the two blocks 1310 and 1312 shown in succession in FIG. 13 may in fact be executed substantially concurrently or the blocks may sometimes be executed in the reverse order, depending upon the functionality involved, as will be further clarified hereinbelow.

The data writing and reading methods may be configured as a program that comprises an ordered listing of executable instructions for implementing logical functions, can be embodied in any computer-readable medium for use by an instruction execution system, apparatus, or device, such as a computer-based system, processor-controlled system, or other system that can fetch the instructions from the instruction execution system, apparatus, or device and execute the instructions. In the context of this document, a “computer-readable medium” can be any medium that can contain, store, communicate, propagate, or transport the program for use by the instruction execution system, apparatus, or device. The computer-readable medium can be, for example, an electronic, magnetic, optical, electromagnetic, infrared, or semiconductor system, apparatus, device, or propagation medium. More specific examples of the computer-readable medium include the following: an electrical connection having one or more wires, a random access memory (RAM), a read-only memory (ROM), an erasable programmable read-only memory (EPROM or Flash memory), and optical fibers. Note that the computer-readable medium could even be paper or another suitable medium upon which the program is printed, as the program can be electronically captured, for instance, by optical scanning of the paper or other medium, then compiled, interpreted or otherwise processed in a suitable manner if necessary, and then stored in a computer memory. In addition, the scope of the present invention includes embodying the functionality of the embodiments of the present disclosure in logic embodied in hardware or software-configured mediums.

It should be emphasized that the above-described embodiments of the present invention are merely examples of possible implementations, set forth for a clear understanding of the principles of the invention. Many variations and modifications may be made to the above-described embodiments of the invention without departing from the principles of the invention. All such modifications and variations are intended to be included herein within the scope of this disclosure and protected by the following claims.

We claim:

1. A memory controller for managing data within a memory component, the memory controller comprising:
a switching circuit having a plurality of data input/output (I/O) terminals and multiple sets of transfer terminals;
a standard transfer circuit connected to one set of transfer terminals;
a fast serial transfer circuit connected to another set of transfer terminals; and
a compression/decompression engine connected to the standard transfer circuit and the fast serial transfer circuit.

2. The memory controller of claim 1, further comprising:
a storage device interface connected between the compression/decompression engine and memory; and
logic circuitry connected to the switching circuit, standard transfer circuit, fast serial transfer circuit, compression/decompression engine, and storage device interface.

3. The memory controller of claim 2, wherein the switching circuit further comprises a plurality of switches, the switches configured to connect the data I/O terminals to one set of the multiple sets of transfer terminals.

4. The memory controller of claim 3, wherein the logic circuitry is configured to, in response to a command from a host to initiate a fast data transfer mode, signal the switching circuit to configure the plurality of switches such that the data I/O terminals are connected to the transfer terminals that are connected to the fast serial transfer circuit.

5. The memory controller of claim 1, wherein the compression/decompression engine comprises:
a compression detector that detects whether the data is in compressed form;
a compression engine that compresses incoming data when the compression detector detects that the data is not in compressed form; and
a data input control circuit that selects between the incoming data and the compressed data, and adds a compression symbol to the selected data to identify the data as either compressed or not compressed.

6. The memory controller of claim 1, wherein the compression/decompression engine comprises:
a decompression detector that detects the compression symbol added to the data retrieved from memory;
a decompression engine that decompresses the data retrieved from memory; and
a data output control circuit that selects between the data retrieved from memory and the decompressed data.

7. A system for storing data, the system comprising:
a host; and
a memory component in electrical communication with the host, the memory component comprising:
at least one memory bank; and
a memory controller connected to the at least one memory bank, the memory controller comprising:
a switching circuit that switches between a parallel transfer mode and a fast serial transfer mode; and
a compression/decompression engine that compresses and decompresses data.

8. The system of claim 7, wherein the memory component is a memory card.

9. The system of claim 8, wherein the memory card has a form factor compatible with one of MultiMediaCard™, Secure Digital™ card, and Memory Stick™ or other memory card form factors that have separate command and data lines.

10. The system of claim 7, wherein the memory controller further comprises a storage device interface that transfers compressed data, transferred in either the parallel transfer mode or the fast serial transfer mode, between the compression/decompression engine and the at least one memory bank.

11. The system of claim 7, wherein the host comprises:
a user device processing system that comprises a data source and a destination circuit;
a switching circuit;
a standard transfer circuit connected between the user device processing system and the switching circuit;
a fast serial transfer circuit connected between the user device processing system and the switching circuit; and
a logic circuit providing a control signal to the switching circuit to configure the switching circuit to operate in one of the parallel transfer mode and the fast serial transfer mode.

12. The system of claim 11, wherein the host further comprises a host connector connected to the standard transfer circuit via the switching circuit when the logic circuit configures the switching circuit to operate in the parallel transfer mode and connected to the fast serial transfer circuit via the switching circuit when the logic circuit configures the switching circuit to operate in the fast serial transfer mode.

13. The system of claim 7, wherein the memory controller further comprises:
a standard transfer circuit;
a fast serial transfer circuit;
a storage device interface; and
logic circuitry.

14. The system of claim 13, wherein the logic circuitry is adapted to configure switches within the switching circuit to switch one of the standard transfer circuit and the fast serial transfer circuit into a data transfer path, such that the system is in the parallel transfer mode when the standard transfer circuit is in the data transfer path and is in the fast serial transfer mode when the fast serial transfer circuit is in the data transfer path.

15. The system of claim 13, wherein the standard transfer circuit comprises push-pull transceivers.

16. The system of claim 13, wherein the fast serial transfer circuit comprises a processing circuit, a transmitting differential amplifier, and a receiving serial differential amplifier.

17. The system of claim 16, wherein the processing circuit comprises:
a phase locked loop circuit that increases a system clock speed; and a serial/deserial circuit.

18. The system of claim 16, wherein the transmitting differential amplifier is configured to pull serial digital data from the processing circuit and convert the serial digital data to a serial differential format including positive and negative components.

19. The system of claim 16, wherein the receiving differential amplifier is configured to receive serial differential data, convert the serial differential data to a serial digital format, and output the serial digital data into the processing circuit.

20. The system of claim 13, wherein the switching circuit comprises a plurality of switches adapted to configure the fast serial transfer circuit in a half-duplex mode.

21. The system of claim 20, wherein, in a fast serial transfer mode, the switching circuit is adapted to configure the plurality of switches such that differential serial data is either transmitted or received along two data lines.

22. The system of claim 13, wherein the switching circuit comprises a plurality of switches adapted to configure the fast serial transfer circuit in a full-duplex mode.

23. The system of claim 22, wherein, in a fast serial transfer mode, the switching circuit is adapted to configure the plurality of switches such that differential serial data is simultaneously transmitted and received along four data lines.

24. A system for transferring data along data paths within a memory component, the system comprising:
means for switching the paths of data transfer to one of a parallel transfer mode and a fast serial transfer mode;
means for transferring data in the parallel transfer mode;
means for transferring data in the fast serial transfer mode;
means for compressing and decompressing data; and
means for controlling the means for switching to configure the means for switching in either one of the parallel transfer mode or the fast serial transfer mode.

25. The system of claim 24, wherein the means for transferring data in the fast serial transfer mode comprises a high transfer rate that is higher than the transfer rate when the path of data transfer is switched to the parallel transfer mode.

26. The system of claim 24, wherein the means for controlling controls the means for switching in response to a command from a host.

27. The system of claim 24, wherein the means for compressing and decompressing data comprises:
means for detecting if data has already been compressed and for transmitting the data to a means for storing data when the data is detected as being compressed;
means for performing a compression algorithm on the data when the means for detecting detects that the data has not been compressed; and
means for adding a compression identifier, indicating the algorithm used for compressing the data, and for transmitting the compressed data and compression identifier to the means for storing data.

28. The system of claim 27, wherein the means for compressing and decompressing data further comprises:
means for retrieving data from the means for storing data, for detecting whether a compression identifier is present, and for transmitting the data to the means for switching when no compression identifier is present; and
means for decompressing the data when a compression identifier is present and for transmitting the decompressed data to the means for switching.

29. A method for transferring data between a host and a memory component, the method comprising the steps of:
determining whether the host requests a fast serial transfer mode;
configuring a switching circuit to connect a plurality of data lines to a plurality of fast serial transfer lines when the host requests the fast serial transfer mode; and
configuring the switching circuit to connect the plurality of data lines to a plurality of parallel transfer lines when the host does not request the fast serial transfer mode.

30. The method of claim 29, further comprising the steps of:
determining whether data has been previously compressed;
compressing data that has not been previously compressed; and
transferring the data to the memory component.

31. The method of claim 30, further comprising the step of adding a compression identifier along with the compressed data to indicate that the data has been compressed.

32. The method of claim 30, further comprising the steps of:
retrieving data from the memory component;
determining whether the retrieved data has a compression identifier;
when the retrieved data has a compression identifier, detecting the compression algorithm used to compress the data;
decompressing the data using a decompression algorithm that is reciprocal to the compression algorithm; and
transferring the decompressed data to the host.

33. An executable sequence stored on a computer-readable medium, the executable sequence comprising:
logic configured to transfer data along a fast serial transfer path;
logic configured to transfer data along a parallel transfer path;
logic configured to store data;
logic configured to switch a data transfer path between one of a plurality of paths through the logic configured to store data and one of a plurality of paths through either the logic configured to transfer data along a fast serial transfer path and the logic configured to transfer data along a parallel transfer path; and
logic configured to control the logic configured to switch.

34. A host device comprising a processor that executes the executable sequence of claim 33.

35. A memory card comprising a memory controller and a plurality of memory banks, wherein the memory controller executes the executable sequence of claim 33.

36. A memory card comprising:
a plurality of memory banks;
a memory controller connected to the plurality of memory banks, the memory controller comprising:
a switching circuit having switching elements configurable in one of a plurality of selectable data transfer modes, each selectable data transfer mode comprising at least one of a plurality of data transfer paths;
a standard transfer circuit connected along a first set of data transfer paths; and a fast serial transfer circuit connected along a second set of data transfer paths.

37. The memory card of claim 36, further comprising a compression/decompression engine connected between the data transfer paths and the plurality of memory banks.

38. The memory card of claim 36, further comprising a body having a form factor compatible with one of MultiMediaCard™, Secure Digital™ card, and Memory Stick™ or other memory card form factors that have separate command and data lines.

39. The memory card of claim 36, wherein the memory banks comprise atomic resolution storage (ARS) devices.

40. The memory card of claim 36, wherein the memory banks comprise magnetic random access memory (MRAM) devices.
